(19) United States
(12) Patent Application Publication
(10) Pub. No.: US 2010/0054690 A1
(43) Pub. Date: Mar. 4, 2010

(54) Flame-retardant fiber optic assemblies

(76) Inventors: Timothy S. Cline, Granite Falls, NC (US); Joseph T. Cody, Hickory, NC (US); Casey A. Coleman, Hickory, NC (US); Johannes I. Greveling, Newton, NC (US); James P. Luther, Hickory, NC (US)

Correspondence Address: CORNING INCORPORATED, INTELLECTUAL PROPERTY DEPARTMENT, SP-TI-3-1, CORNING, NY, 14831, US

(21) Appl. No.: 12/231,113

(22) Filed: Aug. 29, 2008

(51) Int. Cl. G02B 6/00

(52) U.S. Cl. 385/144

(57) ABSTRACT

Disclosed are fiber optic cable assemblies having a composite covering disposed about a portion of a transition location for providing a fiber optic assembly suitable for indoor or indoor/outdoor applications. The composite covering provides a combination of an underlying heat dissipative structure, such as a metal foil along with a high temperature capable substrate, such as mica, thereby providing the desired characteristics for indoor or indoor/outdoor use that a single layer of either material is incapable of providing. The covering may also include an optional flame-retardant wrap as an outer portion for sealing and/or mechanical protection.

### BACKGROUND OF THE INVENTION

1. Field of the Invention

The disclosure is directed to flame-retardant fiber optic assemblies. More specifically, the disclosure is directed to fiber optic assemblies having transition locations that are flame-retardant for indoor or indoor/outdoor use.

2. Technical Background

Fiber optic cables developed for indoor or indoor/outdoor use are required to meet stringent flame and/or smoke ratings, which are tested by independent laboratories. Typically, indoor or indoor/outdoor fiber optic cables are preconnectorized at respective ends with conventional fiber optic connectors and these assemblies meet the desired ratings for the space without modification. As optical fiber moves toward the subscriber and private networks become more advanced, there is a need for more robust and ruggedized fiber optic assemblies to interface with the emerging plug and play networks deployed for indoor and indoor/outdoor applications.

Meeting this emerging demand can be very challenging since the fiber optic assemblies must meet the flame and/or smoke ratings along with still meeting the desired mechanical and optical performance characteristics. One skilled in the art realizes that the flame and/or smoke ratings can be difficult to pass since they generally involve an open flame and require all combustion to cease shortly after removal of the flame. Conversion of outdoor products to nonflammable assemblies by material substitution can be difficult due to the mechanical and environmental requirements that the assemblies must pass. Still further even minor variations in material composition may result in unwanted side effects, and complete material substitutions may exacerbate these unwanted effects. Moreover, designing and testing of the fiber optic assemblies is expensive and time consuming. The fiber optic industry requires a simple, reliable, and effective way to make fiber optic assemblies suitable for indoor and indoor/outdoor applications without extensive redesign and testing of the same.

### BRIEF SUMMARY OF THE INVENTION

The disclosure is directed to various embodiments and methods for fiber optic assemblies having a covering that is flame-retardant for use at a transition location or the like. The covering has multiple components and provides the necessary characteristics to pass burn testing, thereby allowing indoor and/or indoor/outdoor use. The covering includes a heat dissipative structure and a heat resistant structure disposed about a transition location of the fiber optic assembly. Additionally, the covering may include an optional flame-retardant wrap configured for sealing and/or securing the covering such as a flame-retardant heat-shrink material. By way of example, the heat dissipative structure is a foil, such as an aluminum foil and the heat resistant structure is made of mica, but other materials are possible. The covering can have many suitable constructions for application such as individual components applied sequentially or a composite structure such as a wrap or tube for application together. Thus, the fiber optic assemblies are easy to manufacture and reliable.

It is to be understood that both the foregoing general description and the following detailed description present embodiments of the invention, and are intended to provide an overview or framework for understanding the nature and character of the invention as it is claimed. The accompanying drawings are included to provide further understanding of the invention, and are incorporated into and constitute a part of this specification. The drawings illustrate the various example embodiments of the invention and, together with the description, serve to explain the principals and operations of the invention.

### BRIEF DESCRIPTION OF THE DRAWINGS

FIG. 1 is a partial cutaway view of a fiber optic assembly according to one embodiment;

FIG. 2 is a schematic view showing the completed splicing of a preconnectorized assembly with a fiber optic cable to form the fiber optic assembly of FIG. 1;

FIG. 3 is a schematic view showing a heat dissipative structure applied to portion of the fiber optic assembly of FIG. 2;

FIG. 4 is a schematic view showing a heat resistant structure applied to portion of the fiber optic assembly of FIG. 3;

FIG. 5 is a generic cross-sectional view of an explanatory fiber optic assembly; and

FIG. 6 is another embodiment of a demarcation according to the present invention.

### DETAILED DESCRIPTION OF THE INVENTION

Detailed reference will now be made to the drawings in which examples of the present invention are shown. The detailed description uses numerical and letter designations to refer to features of the drawings. Like or similar designations in the drawings and description have been used to refer to like or similar parts of the invention where possible.

The drawings and detailed description provide a full and written description of the examples of the invention, and of the manner and process of making and using these examples, so as to enable one skilled in the pertinent art to make and use them, as well as the best mode of carrying out the invention. The examples set forth in the drawings and detailed description are provided by way of explanation only and are not meant as limitations of the invention. The present invention thus includes any modifications and variations of the following examples as come within the scope of the appended claims and their equivalents.

The figures that are about to be described in detail show exemplary flame resistant coverings or structures for a transition location. These coverings generally include various layers and materials combined to provide flame or burn-through resistance more effectively than, for instance, a stand-alone, flame-resistant heat shrink employed over a spliced area of an enclosure. The components and materials of the composite flame resistant coverings are simple and economical to manufacture and use. Other advantages of the flame resistant coverings will be apparent from the following description and the attached drawings or can be learned through practice of the embodiments and their equivalents.

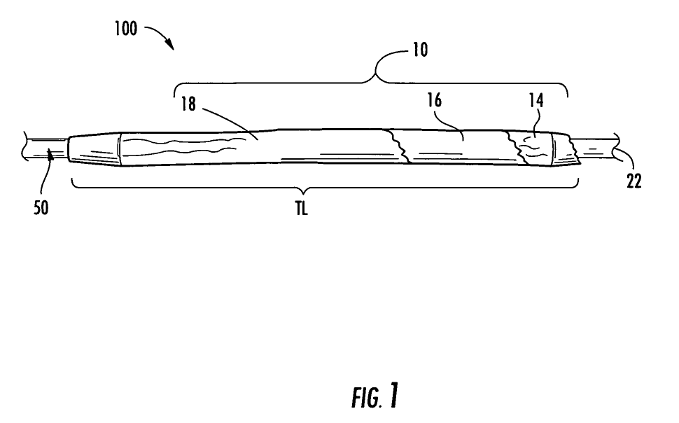

FIG. 1 depicts a partial cutaway view of a fiber optic cable assembly 100 having a covering 10 disposed about a transition location TL. As used herein, transition location TL is a location on the fiber optic assembly where a portion of a cable jacket or other outer coating of the fiber optic assembly has been removed and requires protection thereover and/or a preconnectorized assembly is attached. For instance, FIG. 1 depicts transition location TL between a preconnectorized assembly 50 and an end portion of fiber optic cable 22, thereby making a plug and play assembly. Preconnectorized assembly 50 includes a pigtail (not numbered) with a hardened connector (not shown) suitable for outdoor use as known in the art. Examples of hardened connectors are Opti-Tap® and Opti-tip™ connectors available from Corning Cable Systems of Hickory, N.C., but other suitable hardened connectors and/or preconnectorized assemblies are possible. Further, fiber optic cable 22 may have any suitable design and/or construction. By way of example, both preconnectorized assembly 50 and fiber optic cable 22 have the desired flame-inhibiting characteristics; however, the structure used for closing/covering transition location TL is inherently flammable.

Covering 10 is advantageous since it provides the transition location TL with the suitable characteristics so that fiber optic assembly 100 passes flame-retardant ratings such as UL 746C or the like, thereby qualifying the assembly for indoor or indoor/outdoor applications. Examples of transition locations TL include demarcation locations such as where optical fibers are spliced together such as attaching one or more preconnectorized assemblies, tap locations where optical fibers are extracted from a distribution cable, where fiber optic cables are opened and/or optical fibers are secured to inhibit the migration of excess fiber length along the assembly, and the like. In this embodiment, covering 10 has a multi-layer construction. Covering 10 generally includes a heat dissipative structure 14 and a heat resistant structure 16. Heat dissipative structure 14 is disposed about a portion of transition location TL and acts as a heat shield, whereas heat resistant structure 16 is disposed about a portion of heat dissipative structure 14. An optional flame-retardant wrap 18 such as a heat shrink tubing or wrap may be placed about a portion of the heat resistant structure 16. As discussed below, covering 10 can be a composite structure or formed from individual components.

The combination of a high temperature capable substrate, such as mica, along with an underlying heat dissipative structure, such as metal foil, provides the needed burn-through resistance that a single layer of either material is incapable of providing. Moreover, although flame-retardant wrap 18 is optionally used as part of covering 10 for sealing and/or mechanical protection and for some flame protection, heat shrink alone generally is also insufficient to provide the desired characteristics. Thus, covering 10 provides superior flame-resistance/performance. Additionally, covering 10 is suitable for use over structure that is inherently flammable, thereby providing the desired characteristics for the portion having the underlying flammable structure. By way of example, transition location TL may include an overmold portion that is inherently flammable, but after covering 10 is applied the transition location TL has the desired characteristics.

Heat dissipative structure 14 can be any suitable material, but preferably has a metallic content for effective transfer of the thermal energy. By way of example, heat dissipative structure 14 is formed from a metal foil such as aluminum. The thickness of heat dissipative structure 14 may depend on the material used, but one embodiment has a heat dissipative structure 14 with a thickness between about 0.02 millimeters and about 0.2 millimeters, but other thicknesses are possible. A material such as aluminum acts as a heat shield because of its thermal conduction properties that reduce localized heating. A typical aluminum foil has a thickness greater than about 0.02 millimeters such as between about 0.025 millimeters and 0.075 millimeters. The skilled artisan will recognize that materials other than aluminum may be utilized for heat dissipative structure 14 depending on specific requirements and/or regulations. For instance, relatively thin steel, copper, stainless steel or other metallic tapes wrapped longitudinally or tangentially may be used.

Heat resistant structure 16 is disposed about a portion of heat dissipative structure 14. Heat resistant structure 16 can withstand temperatures of up to about 1000 degrees C. By way of example, heat resistant structure 16 may be mica material such as a mica tape. A suitable heat resistant mica tape is available from Coebgi, Inc. of Dover N.H. Of course, other suitable heat resistant structures are possible. For instance, heat resistant structure 16 may includes a polyurethane/polyphosphazene blends or aramid yarns and is not limited to mica.

The multiple components of covering 10 may have any suitable construction and/or method for applying the same about the transition location TL. For instance, covering 10 may be provided in separate layers such as a metal foil that is formable about a portion of transition location TL and a mica tape. Generally speaking, aluminum foil readily takes the desired set and seals about the transition location without much difficulty. However, the mica tape does not form like the aluminum foil so it may optionally include an adhesive layer or have other means such as applying an adhesive to the structure for forming and/or retaining about transition location TL if necessary. Adhesive layer can be applied to one of the components with any suitable method such as spray, brush, etc. However, it is noted that the adhesive, glue, or the like may be flammable and it should be used sparingly. In other embodiments, covering 10 is a composite structure so that the layers may be applied about the transition location TL together. Moreover, covering 10 may include a further outer layer for sealing and/or mechanical protection

As shown, flame-retardant wrap 18 generally surrounds the transition location TL. Flame-retardant wrap 18 may be manufactured from any suitable material such as flame retardant polyolefin, fluoropolymer (such as fluorinated ethylene propylene (FEP) or PTFE), PVC, neoprene, or silicone elastomer. Flame-retardant wrap 18 may also be a heat shrink material that includes polyolefin heat shrink or ATUM flame retardant heat shrink tubing such as available from Raychem of Menlo Park, Calif., or FEP heat shrinks or Teflon® heat shrink tubing from Zeus Industrial Products, Inc. of Orangeburg, S.C. Of course, suitable heat shrink materials are not limited to the foregoing sources and examples.

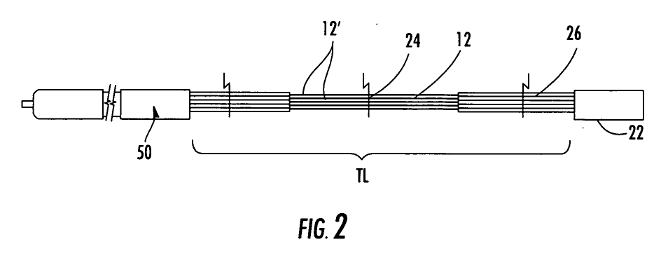

FIGS. 2-4 depict an exemplary method of making fiber optic assembly 100. FIG. 2 schematically depicts preconnectorized assembly 50 having one or more optical fibers 12′ spliced to respective optical fibers 12 of fiber optic cable 22 at splice 24. Once the operations of splicing, excess fiber management, providing a splice protector or protective tube, strain relief of strength members, sealing, overmolding, etc. are completed, the transition location TL must be closed and/or resealed while still meeting the necessary flame or smoke rating for the desired space. The present invention is advantageous since it allows a quick and easy method of reliably and ruggedly closing the transition location TL while still meeting the desired flame, smoke, mechanical, and optical ratings. For instance, fiber optic assembly 100 may be required to meet riser or plenum ratings for indoor applications or other suitable ratings for use in other applications.

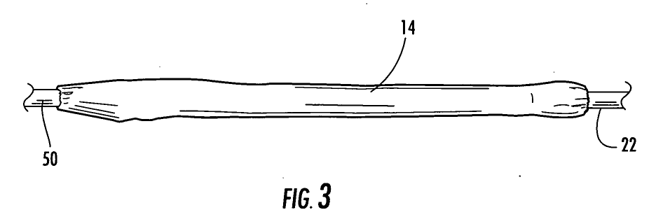

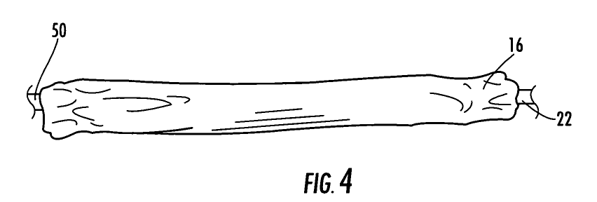

Although FIG. 3 and FIG. 4 depict heat dissipative structure 14 and heat resistant structure 16 applied as separate components they may have a composite structure (i.e., the structures are attached together and can be applied together as described above). Specifically, FIG. 3 is a schematic view showing a heat dissipative structure 14 about a portion of transition location TL. For instance, one or more pieces of metal foil such as aluminum are applied to portion of the transition location TL. Since the metal foil is thin it is relatively easy to plastically deform the same to shape and close the same about the transition location TL. Other methods could use a glue or adhesive to secure the same, but this is not necessary with a thin metal foil. Moreover, the use of glue or adhesive may burn or cause smoke, which is a generally undesired effect.

FIG. 4 is schematic view showing heat resistant structure 16 applied to portion of transition location TL about a portion of heat dissipative structure 14. Heat resistant structure 16 preferably can withstand relatively high temperatures such as up to about 1200 degrees C. By way of example, heat resistant structure 16 is applied over heat dissipative structure 14 so that it generally covers the same.

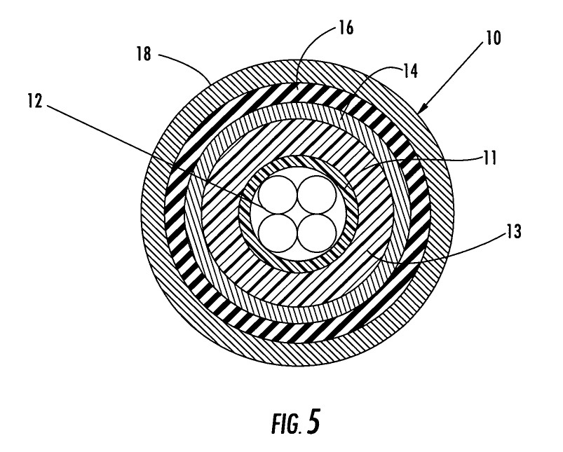

Turning now to FIG. 5, it depicts a generic cross-sectional view of a fiber optic assembly showing the structure of covering 10. A typical structure within covering 10 is depicted for the purposes of illustration. As depicted, optical fibers 12 are disposed within a protective tube 11 that has an overmold 13 disposed thereabout, thereby forming a structure at the transition location TL that is inherently flammable. Thus, covering 10 is provided over this inherently flammable structure so that the fiber optic assembly has the desired characteristics for the intended space. Specifically, heat dissipative structure 14 and heat resistant structure 16 are disposed over the inherently flammable structure. Finally, optional heat shrink wrap 18 is applied for sealing and/or mechanical protection as depicted in FIG. 1, thereby completing fiber optic assembly 100.

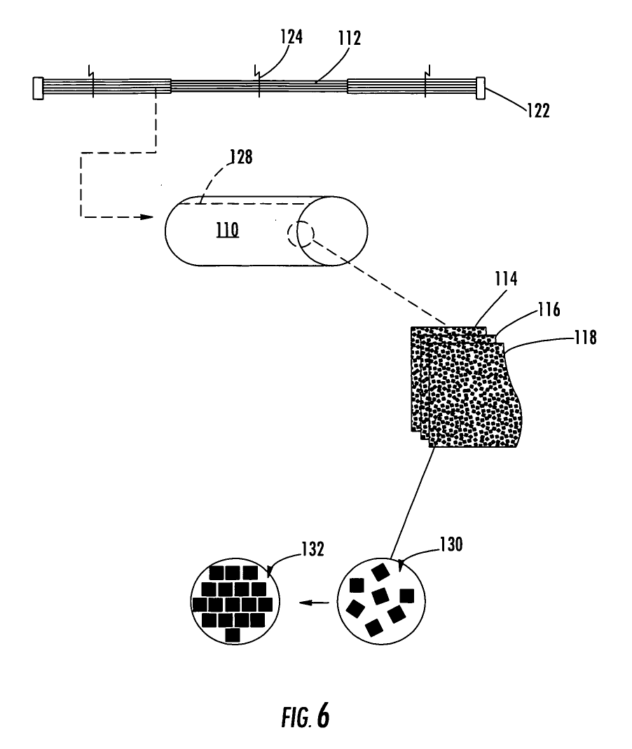

With reference now to FIG. 6, another embodiment of a flame resistant covering 110. Specifically, FIG. 6 shows a fiber optic cable 122 having optical fibers 112 spliced at a splice area 124 to another suitable fiber optic structure. A flame resistant structure 110, which includes multiple layers such as a heat dissipative structure 114, a heat resistant structure 116 and a flame-retardant wrap 118, is slipped onto, wrapped, or otherwise placed over the transition location TL to complete the fiber optic assembly as discussed above. In this example, covering 110 is shaped as a tube or a sleeve that may include a slit or opening 128 to position the covering 110 over the transition location TL. Alternatively, the covering 110 may be a wrap that may be wrapped onto transition location TL.

In any of its alternative forms, covering 110 provides necessary burn-through protection by using flame retardant particles or pieces 130 that may trapped between, for instance, the flame-retardant wrap 118 and the underlying structure of the fiber optic assembly. In this example, the pieces 130 are combinations of mica and aluminum schematically represented as square shapes but may present a honeycomb pattern or have a variety of other geometric forms, the size and distribution of which are such that upon heating, the particles 130 converge or are brought in close proximity to each other to produce a generally solid layer 132 as covering shrinks about the structure. In other embodiments, strips of metal foil having mica particles can be attached to an inner surface of a flame-retardant wrap or heat shrink tubing. Again, mica is suitable as a heat shield and the aluminum (or other suitable material) adds shielding and conduction to minimize localized heating, but, as noted above, other flame resistant and conductive materials may used in the alternative, or in addition to mica and aluminum.

It will be apparent to those skilled in the art that various modifications and variations can be made to the present invention without departing from the spirit and scope of the invention. Thus, it is intended that the present invention cover the modifications and variations of this invention, provided they come within the scope of the appended claims and their equivalents.

1. A fiber optic assembly having a transition location with a covering, the covering comprising:
a heat dissipative structure disposed about a portion of the transition location;
a heat resistant structure disposed about a portion of the heat dissipative structure; and
a flame-retardant wrap disposed about a portion of the heat resistant structure, wherein the covering is disposed over the transition location that includes an overmold portion.

2. The fiber optic assembly of claim 1, wherein the heat dissipative structure is a metal foil.

3. The fiber optic assembly of claim 1, wherein the heat dissipative structure includes aluminum.

4. The fiber optic assembly of claim 1, wherein the heat resistant structure includes mica.

5. The fiber optic assembly of claim 1, wherein the heat dissipative structure, the heat resistant structure and the shrink wrap form a bonded wrap for application about the transition location.

6. The fiber optic assembly of claim 1, wherein the heat dissipative structure, the heat resistant structure and the shrink wrap are formed together in a tubular shape for application about the transition location.

7. The fiber optic assembly of claim 1, wherein the covering includes particles that upon heat shrinking converge to form a unitary layer.

8. The fiber optic assembly of claim 1, wherein the transition location is selected from the group of a demarcation location, a tap location, and a splice location.

9. A fiber optic assembly having a transition location with a covering, the covering comprising:
a metal foil disposed about a portion of the transition location;
a mica material disposed about a portion of the metal foil; and
a flame-retardant heat shrink disposed radially outward of a portion of the heat barrier and a portion of the flame barrier at the transition location, wherein the covering is disposed over the transition location that includes an overmold portion.

10. The fiber optic assembly of claim 9, wherein the metal foil includes aluminum.

11. The fiber optic assembly of claim 9, wherein the metal foil, the mica material and the flame-retardant heat shrink form a bonded wrap for application about the transition location.

12. The fiber optic assembly of claim 9, wherein the metal foil, the mica material and the flame-retardant heat shrink form are formed together in a tubular shape for application about the transition location.

13. The fiber optic assembly of claim 9, wherein the transition location is selected from the group of a demarcation location, a tap location, and a splice location.

14. A method of forming a covering about a transition location of a fiber optic assembly that includes an overmold portion, comprising the steps of:
placing a heat dissipative structure around a portion of the transition location; and
placing a heat resistant structure about a portion of the heat dissipative structure, wherein the covering is disposed over the transition location including the overmold portion.

15. The method of claim 14, further including the step of placing a flame-retardant wrap about a portion of the mica material.

16. The method of claim 15, wherein the heat dissipative structure, heat resistant structure, and flame-retardant heat shrink form a composite structure.

17. The method of claim 14, wherein the heat dissipative structure and heat resistant structure form a composite structure.

18. The method of claim 14, wherein the heat dissipative structure is a metal foil and the heat resistant structure includes mica.

19. A method of forming a covering about a transition location of a fiber optic assembly having an overmold portion, comprising the steps of:
placing a metal foil around a portion of the transition location;
placing a mica material about a portion of the metal foil; and
placing a flame-retardant wrap about a portion of the mica material, wherein the covering is disposed over the transition location including the overmold portion.
